(19) United States
(12) Patent Application Publication
(10) Pub. No.: US 2003/0112476 A1
(43) Pub. Date: Jun. 19, 2003

(54) Business card scanner

(76) Inventors: Wen Shu Chen, Hsinchu (TW); Loi Han, Alhambra, CA (US)

Correspondence Address: COUDERT BROTHERS LLP, 333 SOUTH HOPE STREET, 23RD FLOOR, LOS ANGELES, CA, 90071, US

(21) Appl. No.: 10/017,620

(22) Filed: Dec. 14, 2001

(51) Int. Cl. H04N 1/04

(52) U.S. Cl. 358/474

(57) ABSTRACT

A compact business card scanner incorporating a processing unit and digital storage media for efficient scanning, processing and storage of object image data in image file format, providing display of stored image data as a graphic image of the scanned business card upon an integrated, preferably LCD, display. Stored images may be serially displayed in forward or reverse sequence order, the image displayed may be scrolled, and the portion of the image displayed may be enlarged or reduced in size. Optionally, object image data may be processed and stored in text file format, sorted alphabetically by last name and displayed as text.

### BACKGROUND OF THE INVENTION

A. Field of the Invention

The present invention is directed to a business card scanner that scans, processes stores, and displays business card object image data as digital image data, with optionally a capability to use optical character recognition software to capture, process and store selected data as character data.

B. Description of the Prior Art

Business card scanners are known. However, known business card scanners are limited to optical character recognition type data processing, with character data storage in data files.

### OBJECTS AND SUMMARY OF THE INVENTION

It is an object of the present invention to provide a compact business card scanner that employs a contact image sensor (CIS) module or charge couple device (CCD) module to capture, process, store and display image data representative of the business card data scanned as an object image.

It is a further object of the present invention to provide a sensor module that employs a rod or Selfor lens to focus a business card image onto the image sensors.

It is a further object of the present invention to employ a monorail track upon which the sensor module is movably mounted and moved to accomplish business card scanning.

It is also an object of the present invention to employ a drive system to move the sensor module upon the monorail track in a business card scanner.

It is a further object of the present invention to incorporate a central processor unit (CPU) in a business card scanner to process digital image data received from the image sensors.

It is a further object of the present invention to incorporate in a business card scanner digital storage media to store digital image data representative of the business card object image.

It is a further object of the present invention to incorporate into a business card scanner a liquid crystal display (LCD) to display the additional image data as graphic images upon a screen.

It is a further object of the present invention to incorporate into a business card scanner a manual control that is operationally coupled with the hardware and with installed software elements to permit a serial display of the scanned business card graphical images as well as user manipulation of the graphic image display.

With reference to the above-described objects, the present invention provides a compact business card scanner system which allows convenient scanning, processing, storage, recall and display of graphical image data upon an incorporated display screen, which preferably utilizes a rod or “Selfor” lens to focus the object image onto a CIS or CCD image sensor, and includes, optionally optical character recognition software to recognize, process, store and display characters representative of textual information on a scanned business card.

### BRIEF DESCRIPTION OF THE DRAWINGS

FIG. 1 is a perspective view of a preferred embodiment of the compact business card scanner of the present invention.

FIG. 2 is a cross-sectional view of the FIG. 1 embodiment taken through line 2-2.

FIG. 3 is a cross-sectional view of the FIG. 1 embodiment taken through line 3-3 of FIG. 2 showing the sensor module at the start scan position.

FIG. 4 is a cross-sectional view of the FIG. 1 embodiment taken through line 3-3 of FIG. 2 showing the sensor module at the end scan position.

FIG. 5 is a flow chart illustrating the functional steps describing use of the function control keys and associated installed software of the present invention.

### DESCRIPTION OF THE PREFERRED EMBODIMENTS

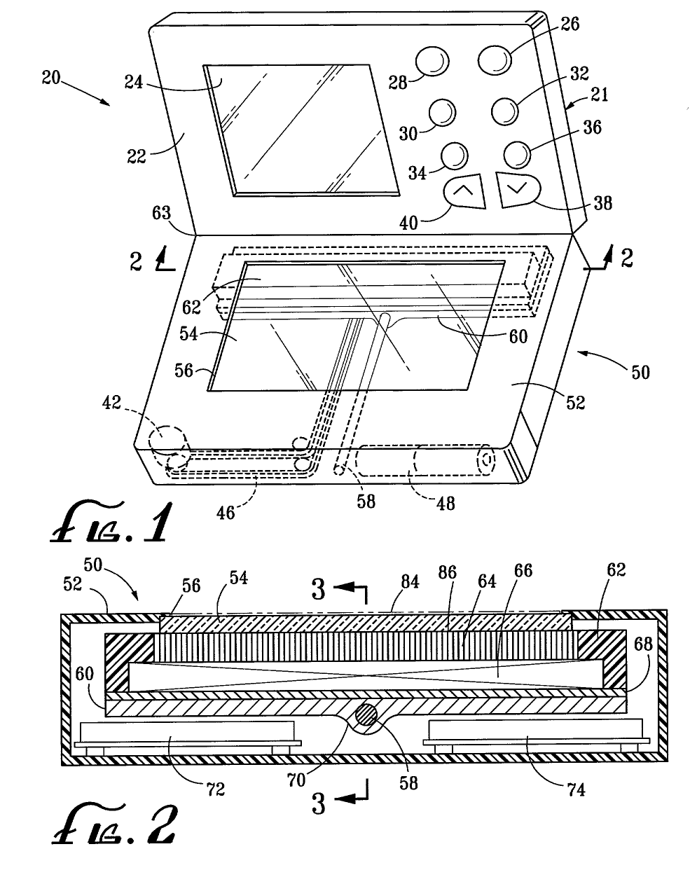

Referring to FIGS. 1 through 4 a preferred embodiment of the present invention is disclosed wherein a compact business card scanner utilizing a rod lens in conjunction with either a CIS or CCD sensor scans a business card and then processes, stores and/or displays corresponding digital data in an image format.

Referring to FIG. 1 a perspective view of a preferred embodiment of the present compact business card scanner 20 is shown. The scanner 20 includes an upper housing 21 having a front surface 22, a display screen 24 and a plurality of function keys including an off/on key 26, an image display key 28, a list key 30, a scan key 32, a zoom down key 34, zoom up key 36, search forward key 38, and search backward key 40. Scanner 20 additionally includes a lower housing 50 having a top surface 52, platen 54, a recess in the top surface 56. Lower housing 50 also includes a monorail 58, stepper motor and gears 42, a timing belt drive 46, rechargeable battery 48, module carriage 60, and sensor module casing 62. As also shown, upper housing 21 and lower housing 50 are mechanically joined by hinge 63.

The preferred overall exterior dimensions of the scanner 20 with the upper housing 21 closed upon the lower housing 50 is 6.5 inches by 3.5 inches by 0.75 inches, although alternative embodiments of the scanner may be fabricated having different exterior dimensions or shape. Further, the preferred dimensions of the platen 54 is 2.0 inches by 3.5 inches by 0.08 inches.

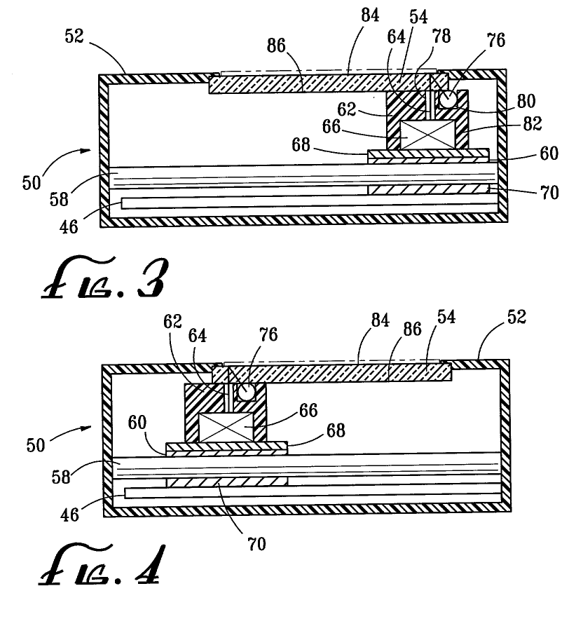

Referring to FIG. 2 the scanner of the present invention employs, preferably, a contact image sensor (CIS) module of the type described in U.S. Pat. No. 5,907,413, which is incorporated by reference herein. Platen 54, preferably made of glass, is set into a top surface 52 such that a recess at 56 is created between top surface 52 and the top surface of the platen 54. Recess 56 facilitates positioning a business card to be scanned face down on the top surface 84 of the platen 54 by functioning as an abutment surface. The lower housing 50 includes a sensor module casing 62 with a rod lens array 64 positioned adjacent the second, or lower surface 86 of the platen 54. Positioned underneath the rod lens array 64 in the sensor module casing 62 is a sensor array 66, which together with sensor module casing 62 is affixed to the top surface of a ceramic substrate 68. As shown in FIG. 3, the ceramic substrate 68 is in turn affixed to the top surface of module carriage 60.

As shown in FIGS. 1 and 2, the module carriage 60 is mounted on a monorail 58 adapted and positioned to be transported from one end of the scanner to its opposite end through use of timing belt drive 46 and stepper motor 42. The module carriage 60 includes a portion or region 70 shown in FIG. 2 which extends under the module and the carriage and provides a bore, or channel, through which the monorail 58 may pass.

Referring to FIG. 2 a central processor unit (CPU) 72 is shown in a preferred location within lower housing 50, together with a digital data storage media 74 at a preferred location within the lower housing 50. CPU 72 is operably connected to the battery power source 48 and is in electrical communication with the digital data storage media 74, the sensor array 66, the display screen 24, the plurality of function keys 26, 28, 30, 32, 34, 36, 38, and 40, as well as stepper motor 42 and light source 76. Scanner 20 is energized by a battery power source 48 or, alternatively by an optional external electric power source.

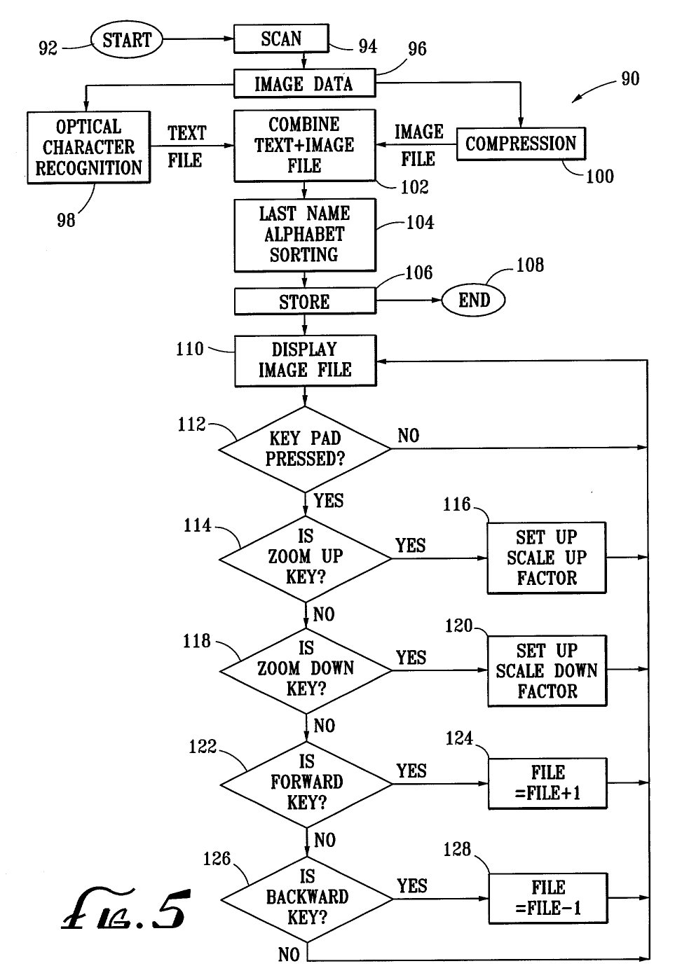

With reference to FIGS. 3 and 4, the configuration of the sensor module casing 62 will be described. FIG. 3 depicts the module carriage 60 in the start scan position, adjacent a first end of the housing 50, while FIG. 4 depicts the module carriage 60 in the end scan position, adjacent a second, opposite end of the housing 50. As shown in FIGS. 3 and 4, sensor array casing 62 contains a recess 80 adapted to receive the light source with an included cylindrical lens 76. At recess 80, the light source with included cylindrical lens 76 are adapted and focused so that light is directed to a line just above the individual focusing elements on each of the rod lenses of the lens array 64 across the width of the array. The sensor module casing 62 contains a bore or channel 78 to receive each of the lenses of the rod lens array 64. The sensor module casing 62 further contains a recess 82, in communication with recess 78, and adapted to receive sensor array 66.

With reference to FIG. 5, a flow chart 90 illustrating the functional steps associated with the operation of the invention, use of the function keys and associated installed software is described. With off/on key 26 in the “on” position and the carriage module 60 in the position as shown in FIG. 3, depression of scan key 32 initiates scanning function start 92 which begins scan 94 and movement of the module carriage 60 through operation of stepper motor and gears 42 through operation of a central processing unit 72 to cause movement of the timing belt drive 46. Once the module carriage 60 reaches the position on monorail 58 shown in FIG. 4, the module carriage is returned automatically to the start scan position shown in FIG. 3. Image data is acquired at step 96 during the scan 94 by illumination of a light source 76 through the operation of CPU 72, and an object image is focused on the sensor array 66 by the rod lens 64. The sensor array 66 detects the object image and converts the object image to digital data representative of the object image.

Utilizing conventional software, ScanWizard version 5.5 or higher being preferred, the digital data is processed as described with reference to FIG. 5. The representative image digital data is conveyed to an optical character recognition software routine at step 98 for generation of a text file. The representative image digital data generated at step 96 is conveyed to a data compression software routine 100 to generate an image file which is combined with the text file at step 102. The combined text and image file 102 is provided to an algorithm 104 designed to identify the last name of the person inscribed on the business card to sort the last name alphabetically and to store the file and digital data storage media at step 106. Operation of list key 30 selects display of stored text files only, listed alphabetically by last name, which may be scrolled forward or backward by operation of the forward key 38 or backward key 40, respectively.

In an alternative preferred embodiment, the step 98 optical character recognition and step 104 last name alphabetical sorting may be omitted, thus providing for image files storage only at step 106. In either embodiment, the scanning, representative digital data processing and storage steps are complete at step 108.

Upon completion of file storage at step 106 the stored representative, image digital data file is processed to be displayed on display screen 24 at step 110 when the image display key 28 is depressed. Installed software routines then query whether a scanner function key from the keypad is depressed at step 112. If, for example, the zoom up key 36 is depressed at step 114, then software routine 116 applies a predetermined, conventional algorithm to set up a scale up factor that functions to increase the scale of the displayed image. If the zoom down key 34 is depressed at step 118, then software routine 120 applies a predetermined, conventional algorithm to set up a scale down factor that functions to decrease the scale of the displayed image. If the forward key 38 is depressed at step 122, then software routine 124 applies a predetermined, conventional algorithm to display the file assigned the next higher file number than the image currently displayed. If the backward key 40 is depressed at step 126, then software routine 128 applies a predetermined, conventional algorithm to display the file assigned the next lower file number than that of the image currently displayed.

As should now be appreciated, a novel compact business card scanning system has been described. The business card scanning system permits the efficient scanning and storage of graphic information, as well as, optionally, text contained on a business card for display of a graphic image of the business card. When used, the text scanning and processing functions provide for alphabetical sorting of the last name inscribed on the business card for user convenience. The images are stored and may be reviewed by a serial display in forward or backward sequence order.

It will be understood that certain features and subcombinations are of utility and may be employed without reference to other features and subcombinations as they are outlined within the description above and within the claims appended hereto. While the preferred embodiments and application of the invention have been described, it is apparent to those skilled in the art that the objects and features of the present invention are only limited as set forth in the claims appended hereto.

We claim:

1. A compact business card scanner comprising:
a housing;
a platen positioned in the housing, the platen having a first surface adapted to support a business card to be scanned, and having a second surface opposed to the first surface;
a sensor module mounted within the housing, adapted for reciprocal motion within the housing and adapted to convert an optical image of a scanned business card into digital data representative of said optical image; and
a display device positioned in the housing and adapted to display a graphic image of the scanned business card.

2. A compact business card scanner comprising:
a first housing and a second housing movably attached to said first housing;
a platen positioned in the first housing, the platen having a first surface adapted to support a business card to be scanned;
a sensor module mounted within the first housing, adapted to be moved under the platen and adapted to convert an optical image of a scanned business card into digital data representative of said optical image; and
a display device positioned in the first housing or in the second housing and adapted to display an image of the scanned business card.

3. The compact business card scanner of claim 1 or claim 2 wherein the sensor module is a contact image sensor module.

4. The compact business card scanner of claim 1 or claim 2 wherein the sensor module is a charge coupled device sensor module.

5. The compact business card scanner of claim 1 or claim 2 wherein the display device is a liquid crystal display (LCD) screen.

6. A method of scanning a business card comprising:
providing a business card to be scanned;
providing a compact business card scanner having a platen;
providing a sensor module within said scanner;
placing the business card face down on the platen;
moving the sensor module under the platen;
scanning the business card with the sensor module to generate representative image digital data;
processing the generated digital data in a processing unit;
storing the digital data in digital data storage media; and
displaying the digital data graphically utilizing a display device.

7. The compact business card scanner of claim 1 or claim 2 further including at least one processing unit (CPU) and coupled digital data storage media.

8. The compact business card scanner of claim 7 wherein the digital data storage media is removable.

9. The compact business card scanner of claim 7 further including installed software adapted for scanning optical images, converting optical image data to representative digital data, processing and storing said digital data in image file format, and displaying graphically the digital data image files.

10. The compact business card scanner of claim 7 further including installed software adapted for scanning optical images, converting optical image data to representative digital data, processing said digital data by character recognition routines to generate text files, sorting and storing said text files, and displaying the digital data text files as text.

11. The compact business card scanner of claim 7 further including installed software adapted to provide a user interface for selection of displayed image and control of displayed image zoom in, zoom out and scroll functions.
